(19) United States
(12) Patent Application Publication
(10) Pub. No.: US 2006/0047648 A1
(43) Pub. Date: Mar. 2, 2006

(54) Comprehensive query processing and data access system and user interface

(76) Inventor: Eric Martin, Chester Springs, PA (US)

Correspondence Address: Siemens Corporation;Intellectual Property Department, 170 Wood Avenue South, Iselin, NJ, 08830, US

(21) Appl. No.: 11/203,767

(22) Filed: Aug. 15, 2005

Related U.S. Application Data
(60) Provisional application No. 60/604,168, filed on Aug. 24, 2004.

(51) Int. Cl. G06F 17/30

(52) U.S. Cl. 707/4

(57) ABSTRACT

A system, for acquiring and processing data from multiple different data sources, includes a first source, a second source, and a query processor. The first source of predetermined configuration information associates a received query for information in a first data format with a corresponding particular structured data request format and multiple different data sources. The second source of predetermined configuration information associates the particular structured data request format with multiple different data sources. The query processor uses the first and second source of predetermined configuration information for translating the received query for information in the first data format to multiple queries in different data formats for communication to the multiple different data sources.

### CROSS-REFERENCE TO RELATED APPLICATIONS

The present application is a non-provisional application of provisional application having Ser. No. 60/604,168 filed by Eric Martin on Aug. 24, 2004.

### FIELD OF THE INVENTION

The present invention generally relates to computer information systems. More particularly, the present invention relates to a comprehensive query processing and data access system and user interface.

### BACKGROUND OF THE INVENTION

Prior computer information systems typically employ hard-coded logic to support collection of data and display of information. The prior systems are typically coded specifically to the type of information and often to the source of the information. The specific coding to an individual type of information being collected limits the evolution of the software and site modifications to software release interfaces. The nature of the specific coding and the required testing of the specific coding often leads to lengthy lead times for a product development cycle. The existing systems also fail to provide for the consolidation of information from multiple sources of information. Accordingly, there is a need for a comprehensive query processing and data access system and user interface that overcomes these and other disadvantages of the prior systems.

### SUMMARY OF THE INVENTION

A system, for acquiring and processing data from multiple different sources, includes a first source, a second source, and a query processor. The first source of predetermined configuration information associates a received query for information in a first data format with a corresponding particular structured data request format and multiple different data sources. The second source of predetermined configuration information associates the particular structured data request format with multiple different data sources. The query processor uses the first and second source of predetermined configuration information for translating the received query for information in the first data format to multiple queries in different data formats for communication to the multiple different data sources.

### BRIEF DESCRIPTION OF THE DRAWINGS

FIG. 1 illustrates a system for acquiring and processing data from multiple different sources, according to invention principles.

FIG. 2 illustrates the system, as shown in FIG. 1, in more detail, according to invention principles.

FIG. 3 illustrates the system, as shown in FIGS. 1 and 2, in more detail, and a corresponding method, according to invention principles.

FIG. 4 illustrates a class responsibility collaboration (CRC) card for a data source interface, according to invention principles.

FIG. 5 illustrates a class responsibility collaboration (CRC) card for an action provider interface, according to invention principles.

FIG. 6 illustrates a class responsibility collaboration (CRC) card for an action provider plug-in, according to invention principles.

FIG. 7 illustrates a class responsibility collaboration (CRC) card for a data SOA adapter, according to invention principles.

FIG. 8 illustrates a class responsibility collaboration (CRC) card for a results consolidator, according to invention principles.

FIG. 9 illustrates a user interface window generated from a generic display configuration, according to invention principles.

FIG. 10 illustrates a user interface window, as shown in FIG. 9, combined into another generic user interface configuration to provide a higher level display, according to invention principles.

FIG. 11 illustrates a function of the user interface window, as shown in FIG. 10, according to invention principles.

FIG. 12 illustrates a method performed by a results consolidator, according to invention principles.

FIG. 13 illustrates a method for processing sub-queries, according to invention principles.

FIG. 14 illustrates a browser window incorporating the user interface windows, as shown in FIGS. 9 and 10, according to invention principles.

### DETAILED DESCRIPTION OF THE PREFERRED EMBODIMENTS

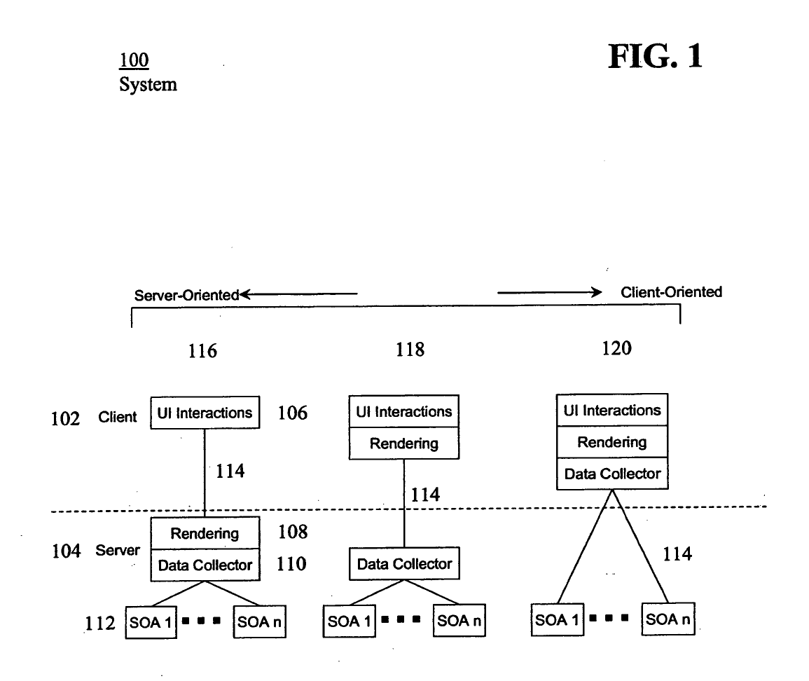

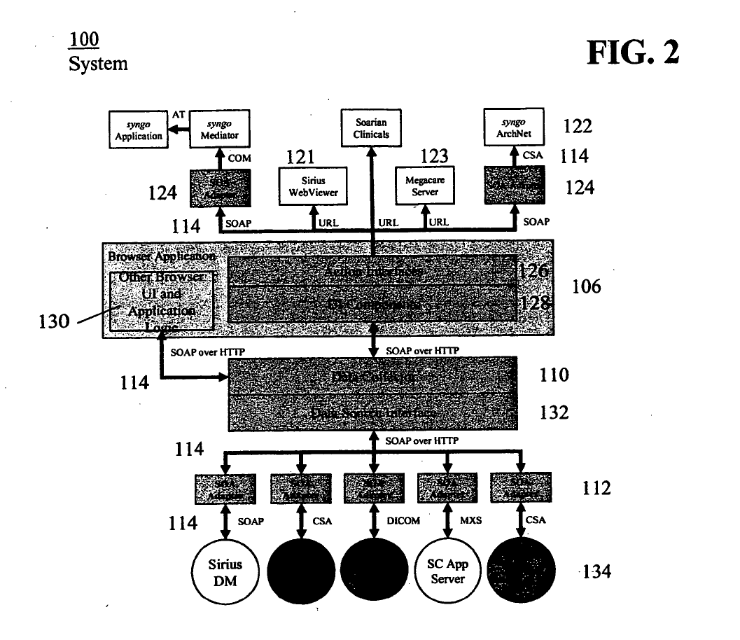

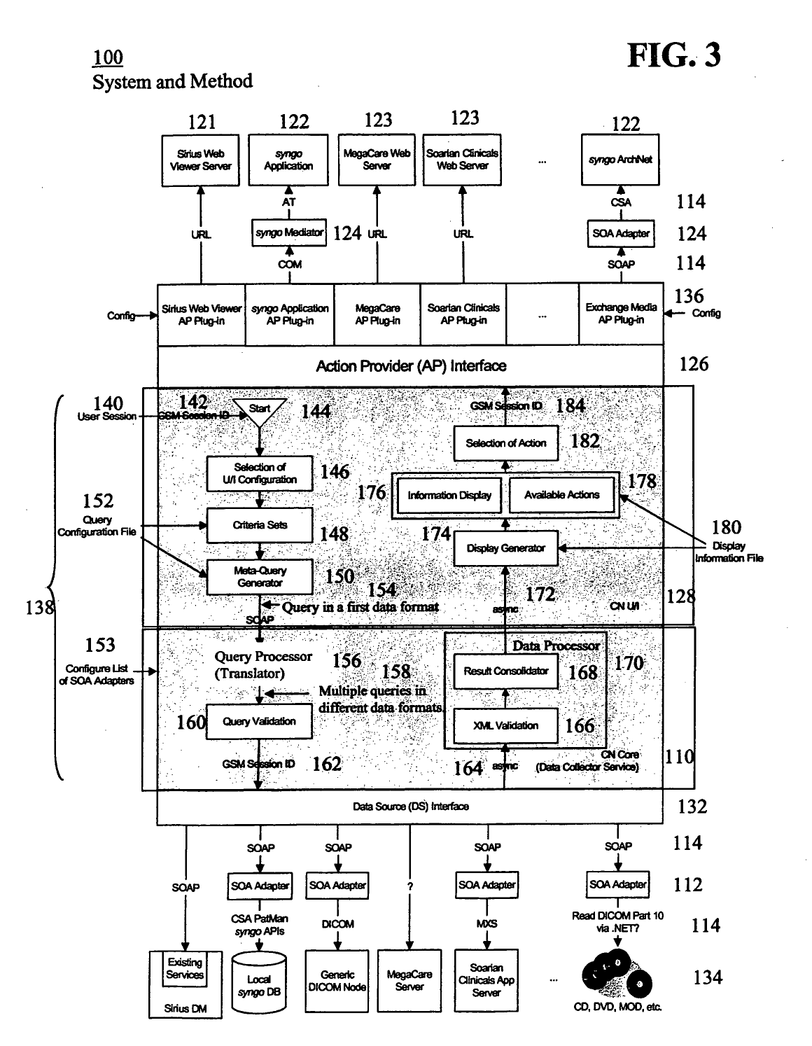

FIG. 1 illustrates a system 100 for acquiring and processing data from multiple different sources. The system 100 includes a client 102 and a server 104, each of which are well know to those skilled in the art. The functions of the client 102 or the server 104 include providing user interface interactions 106 by a user interface, rendering 108 by a query generator 150 (see FIGS. 2 and 3) and a display generator 174 (see FIGS. 2 and 3), data collection 110 by a data collector, and service-oriented architecture (SOA) adapters 112 (e.g., 1 to n) via a configuration list 153 of SOA adapters (see FIGS. 2 and 3). An individual SOA adapter 112 communicates with corresponding data sources 134 (e.g., 1 to n) (shown in FIGS. 2 and 3). The various functions 106, 108, 110, and 112 communicate with appropriate functions via a communication path 114.

The system 100 of FIG. 1 provides three examples 116, 118, and 120 of how the functions of the client 102 or the server 104 are allocated between the client 102 and the server 104. Any allocation of functions between the client 102 and the server 104 may be supported by the system 100. Further, the system 100 may also support additional functions that are not shown.

In example 116, the client supports the user interface interactions 106, and the server 104 supports the rendering 108, the data collection 110, and the SOA 112. As shown by the variable client-server continuum across the top of the examples 116, 118, and 120, example 116 is a more server-orientated allocation, since the client 102 supports one function 106, and the server 104 supports three functions 108, 110, and 112.

In example 118, the client supports the user interface interactions 106 and the rendering 108, and the server 104 supports the data collection 110 and the SOA 112. As shown by the variable client-server continuum across the top of the examples 116, 118, and 120, example 118 is a balanced client-server-orientated allocation, since the client 102 supports two functions 106 and 108, and the server 104 supports two functions 110 and 112.

In example 120, the client supports the user interface interactions 106, the rendering 108, and the data collection 110, and the server 104 supports the SOA 112. As shown by the variable client-server continuum across the top of the examples 116, 118, and 120, example 120 is a more client-orientated allocation, since the client 102 supports three functions 106, 108, and 112, and the server 104 supports one function 112.

The system 100 may be employed by any type of enterprise, organization, or department, such as, for example, providers of healthcare products and/or services responsible for servicing the health and/or welfare of people in its care. For example, the system 100 represents a hospital information system. A healthcare provider provides services directed to the mental, emotional, or physical well being of a patient. Examples of healthcare providers include a hospital, a nursing home, an assisted living care arrangement, a home health care arrangement, a hospice arrangement, a critical care arrangement, a health care clinic, a physical therapy clinic, a chiropractic clinic, a medical supplier, a pharmacy, and a dental office. When servicing a person in its care, a healthcare provider diagnoses a condition or disease, and recommends a course of treatment to cure the condition, if such treatment exists, or provides preventative healthcare services. Examples of the people being serviced by a healthcare provider include a patient, a resident, a client, and an individual.

The system 100 may be fixed and/or mobile (i.e., portable), and may be implemented in a variety of forms including, but not limited to, one or more of the following: a personal computer (PC), a desktop computer, a laptop computer, a workstation, a minicomputer, a mainframe, a supercomputer, a network-based device, a personal digital assistant (PDA), a smart card, a cellular telephone, a pager, and a wristwatch. The system 100 and/or elements contained therein also may be implemented in a centralized or decentralized configuration.

The communication path 114 (otherwise called network, bus, link, connection, channel, etc.) represents any type of protocol or data format including, but not limited to, one or more of the following: an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, a Campus Area Network (CAN) protocol, a Metropolitan Area Network (MAN) protocol, a Home Area Network (HAN) protocol, an Institute Of Electrical And Electronic Engineers (IEEE) bus compatible protocol, a Digital and Imaging Communications (DICOM) protocol, and a Health Level Seven (HL7) protocol.

The system 100 and/or elements contained therein may be implemented in hardware, software, or a combination of both, and may include one or more processors. A processor is a device and/or set of machine-readable instructions for performing task. The processor includes any combination of hardware, firmware, and/or software. The processor acts upon stored and/or received information by computing, manipulating, analyzing, modifying, converting, or transmitting information for use by an executable application or procedure or an information device, and/or by routing the information to an output device. For example, the processor may use or include the capabilities of a controller or microprocessor.

The executable application, typically stored in a memory device, comprises code or machine readable instruction for implementing predetermined functions including, for example, those of an operating system, a software application program, a healthcare information system, or other information processing system, for example, in response user command or input. An executable procedure is a segment of code (i.e., machine readable instruction), sub-routine, or other distinct section of code or portion of an executable application for performing one or more particular processes, and may include performing operations on received input parameters (or in response to received input parameters) and providing resulting output parameters. A calling procedure is a procedure for enabling execution of another procedure in response to a received command or instruction. An object comprises a grouping of data and/or executable instructions or an executable procedure.

The user interface 106 permits bi-directional exchange of data and typically includes a data input device (not shown) and a data output device (not shown).

The data input device typically provides data to a processor in response to receiving input data either manually from a user or automatically from an electronic device, such as a computer. For manual input, the data input device is a keyboard and a mouse, but also may be a touch screen, or a microphone with a voice recognition application, for example. For automatic input, the data input device is a data modem.

The data output device typically provides data from a processor for use by a user or an electronic device, such as a computer. For output to a user, the data output device is a display that generates display images in response to receiving the display signals from the processor, but also may be a speaker or a printer, for example. For electronic output to an electronic device, the data output device is a data modem.

The system 100 provides significant advantages over the hard coded approach by permitting description data to be collected through configuration. In general, the system 100 reads from descriptive configuration data: a description of available data sources, the “view types” that an individual data source supports, and a description of an individual data view type. The system 100 then queries an individual data source for a user selected view type, retrieves the information returned by an individual queried data source 134 for the view type, consolidates the information gathered by multiple data sources 134, and displays the information in a format as requested by display configuration. A user may then trigger an activity on selected information by an external application.

The system 100 advantageously provides the following features:

1. Description of the data view types for collection and display permits the utility of the system to be augmented through configuration without any re-coding or recompilation of programs written in traditional programming languages.

2. The descriptive configuration includes information permitting automatic consolidation of data from multiple data sources.

3. Configuration data also permits the system 100 to create end-user displays of data view types and trigger activity by external applications with the context of information from the displayed data view type as selected by the user.

4. The configuration of the data view type provides for the description of data having an internal hierarchical structure. The configuration information allows the system 100 to query an individual sub-level of the hierarchical structure independently so that large collections of information may be scanned in a reasonable manner with sub-queries being initiated for the selected portions of the data tree as a user incrementally navigates through a data tree structure.

FIG. 2 illustrates the system 100, as shown in FIG. 1, in more detail. In addition to FIG. 1, other components of the system 100 in FIG. 2 includes a web viewer 121, external applications 122, a server 123, SOA adapters 124 between the user interface 106 and the applications 122, action provider (AP) interfaces 126, user interface components 128, and other browser user interface and application logic 130 in the user interface 106, a data source interface 132, and data sources 134.

The system 100 of FIG. 2 is deployed, for example, in a Web-based standalone configuration. The system 100 of FIG. 2 includes the SOA adapters 124, the action interfaces 126 and the user interface components 128 in the user interface 106, the data collector 110, the data source interface 132, and the SOA adapters 112. The web viewer 121, the external applications 122, the server 123, the other browser user interface and application logic 130, and the data sources 134 interface with the system 100.

The data sources 134 may be of any type including, for example, compact disc (CD), digital video disk (DVD), an application server, a database, a generic DICOM node, and a digital memory (DM). The data sources 134 may store any type of data in any format.

FIG. 3 illustrates the system 100, as shown in FIGS. 1 and 2, in more detail, together with a corresponding method 138. In addition to FIGS. 1 and 2, the system 100 in FIG. 3 includes action provider (AP) plug-ins 136 and the method 138.

A user logs in and has a user session 140 that provides a session identification (ID) 142 to start 144 the method 138. The method 138 may be an executable application embodied in a tangible storage medium (e.g., memory device) for implementing the method 138.

At step 146, a user selects a user interface configuration (i.e., a layout) from the user interface 128. Alternatively, the user interface 128 employs a default user interface configuration based on user role or personal preference.

At step 148, the system 100 or the user selects a criteria set via a query configuration file 152 to request information from one or more data sources 134, and the request is sent to a meta-query generator 150. The meta-query generator 150 processes the request and generates a meta data-query 154, otherwise called a particular structured data request format, having a first data format. The query configuration file 152 represents a first source of predetermined configuration information for associating a received query 154 for information in a first data format with a corresponding particular structured data request format and multiple different data sources 134.

Upon initialization and when demanded by either the user interface 128 or an external application 122 or 123, the data collector service 110 updates a configuration list 153 of information regarding available SOA adapters 112. The configuration list 153 of available SOA adapters 112 represents a second source of predetermined configuration information for associating the particular structured data request format with multiple different data sources. The configuration list 153 of available SOA adapters 112 also includes corresponding communication protocols (e.g., reference number 114) used for interrogating multiple different data sources 134. The first 152 and the second 153 source of predetermined configuration information may be the same or different sources.

At step 156, a query processor translates the meta-query 154 having a first data format into multiple queries 158 having different data formats, in accordance with the data source interface 132. More particularly, the query processor uses the first 152 and the second 153 source of predetermined configuration information for translating the received query 154 for information in the first data format to multiple queries 158 in different data formats for communication to the multiple different data sources 134 using the corresponding communication protocols.

At step 160, the system 100 validates the multiple queries 158 having different data formats to ensure the CN U/I provided a semantically correct query. The system 100 sends the multiple queries 158 having different data formats, along with the user session ID 142 to the various data sources 134, via the data source interface 132 and sometimes via the SOA adapters 112, for the requested information.

The data source interface 132 advantageously defines a standard procedure (i.e., a protocol) for the data source interface 132 and the SOA adapters 112 to permit the data sources 134 to communicate with the data collector service 110.

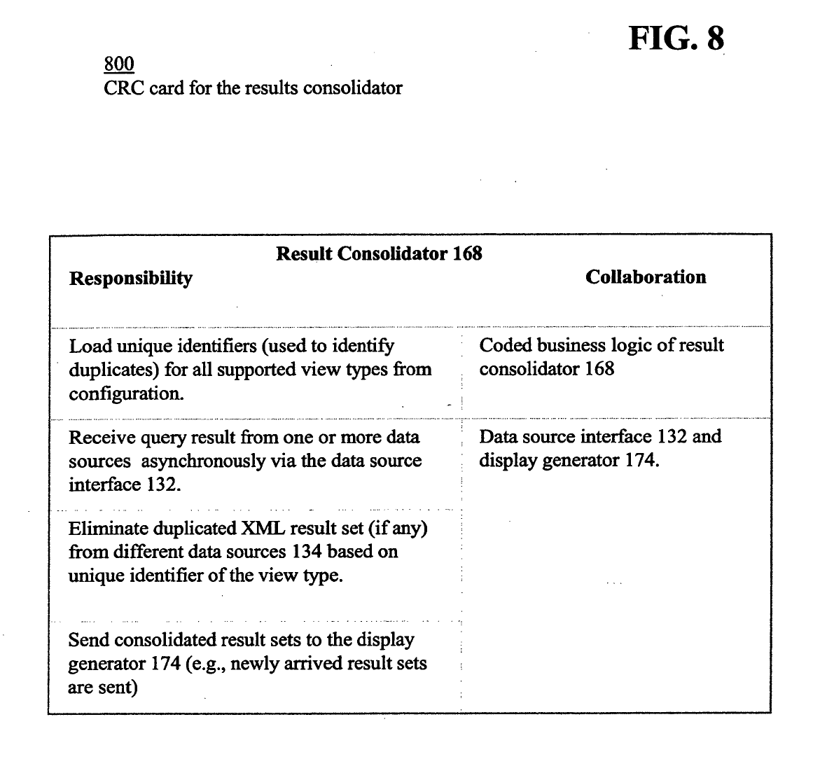

The particular structured data request format 154 includes associated ancillary data for use in processing data elements, in query reply messages 164 received in response to the multiple queries 158 communicated to the multiple different data sources 134 by one or more of the following methods: (a) eliminating redundant replicated data elements by the result consolidator 168 (see FIG. 8); and (b) substituting a first received data element for a second received data element by the query processor 156.

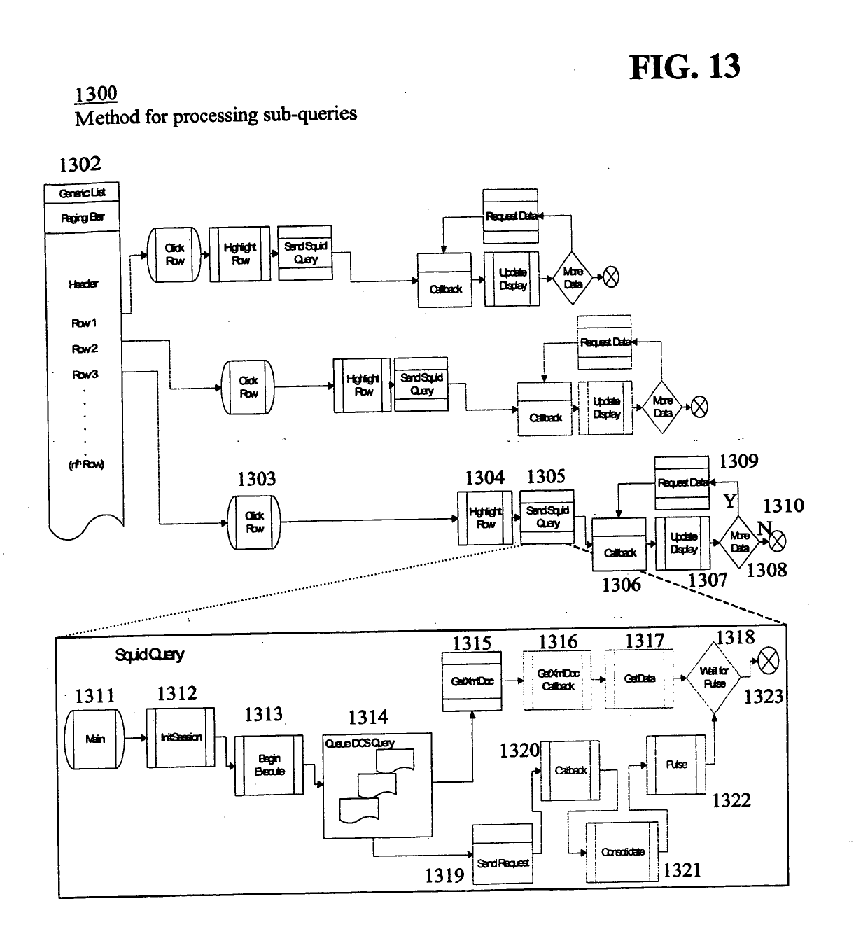

The system 100 uses the ancillary data to process and sort data elements for such purposes, for example, processing sub-queries (see FIG. 13), and formatting received information for display. Examples of ancillary data are provided in the examples near the end of this description.

The particular structured data request format 154, including the ancillary data, comprises meta data of the particular structured data request format 154.

The query processor 156 substitutes the first received data element for the second received data element in response to information indicating a predetermined priority of the multiple different data sources 134.

The particular structured data request format 154 includes associated ancillary data for use in sorting data elements, in query reply messages 164 received in response to the multiple queries 158 communicated to the multiple different data sources 134. The system 100 sorts in response to one or more of the following: (a) a user command received via a displayed user interface image, and (b) automatically, based on predetermined configuration information.

The particular structured data request format 154 includes associated ancillary data for use by the query processor 156 in dividing the received query into a plurality of sub-queries (see FIG. 13) for communication to the multiple different data sources 134.

The query processor 156, also in response to the particular structured data request format 154 including the ancillary data, communicates a first set of selected sub-queries of the multiple sub-queries (see FIG. 13) to a first source of the multiple different data sources 134, and a different second set of selected sub-queries (see FIG. 13) of the multiple sub-queries to a second source of the multiple different data sources 134.

The query processor 156, also in response to the particular structured data request format 154 including the ancillary data, communicates a common set of selected sub-queries (see FIG. 13) of the multiple sub-queries to the multiple different data sources 134.

The particular structured data request format 154 includes associated ancillary data for use in formatting for display 176, data elements received in query reply messages 164 received in response to the multiple queries 158 communicated to the multiple different data sources 134.

The query processor 156 initiates communication of the multiple queries 158 in different data formats together with session information 142. The session information 142 identifies a user initiating the received query, and is used by a data source 134 in determining whether the user is authorized to receive requested information.

The query processor 156 parses and examines the multiple queries 158 in the different data formats to determine whether individual queries are compatible with corresponding destination data sources 134. The query processor 156 makes this determination, for example, by determining whether the individual queries are semantically correct.

The query processor 156 translates the received query 154 for information in the first data format to the plurality of queries 158 in different data formats by translating the received query 154 into a different data format having a syntax compatible with a communication interface of a data source 134.

At step 164, the system 100 asynchronously receives data via the data sources 143, via the data source interface 132 and via the SOA adapters 112, communicates the received data to a data processor 170 for further processing.

At step 166, the data processor 170 validates the received data to produce validated query response data. The format of the received data may be, for example, in extended hypertext markup language (XML), standard generalized markup language (SGML), or in hypertext markup language (HTML).

At step 168, the data processor 170 consolidates the validated query response data using a results consolidator. More particularly, the data processor 170 receives query reply messages 164 in response to the multiple queries communicated to the multiple different data sources 134, and collates data in the query reply messages 164 in a desired format in response to the received query and/or the particular structured data request format.

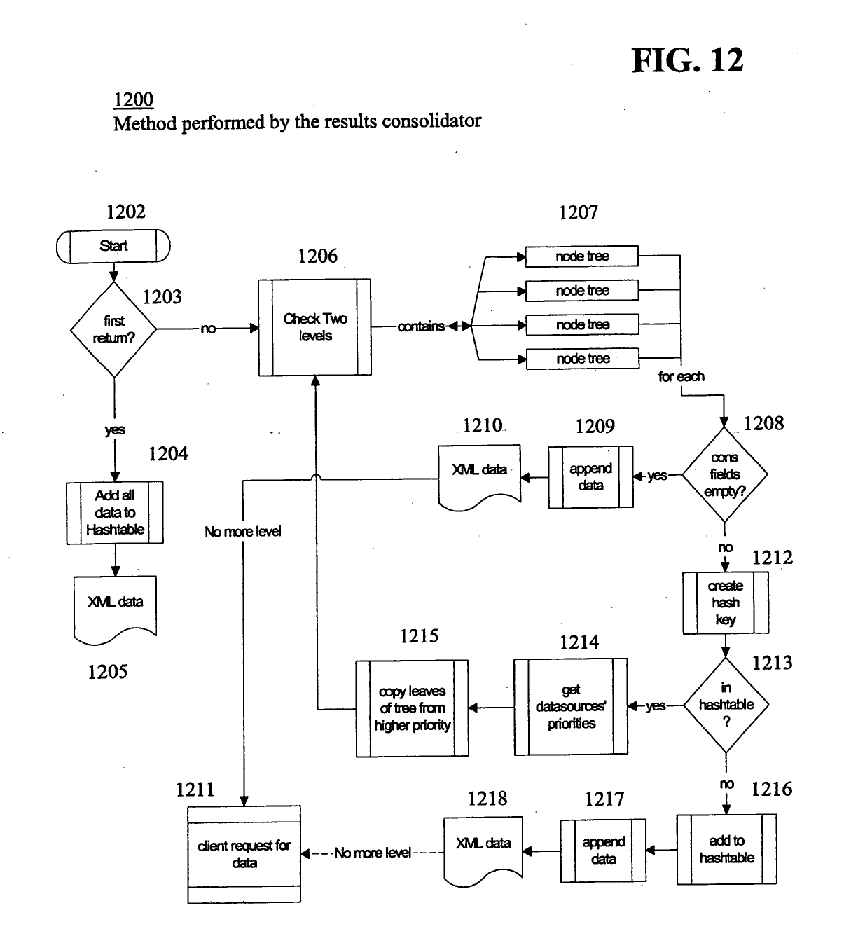

The query response data are consolidated based on the view type information and the consolidation request initiated by the user. An individual view type's XML schema definition (XSD) file defines levels that the data may be consolidated at and the which to consolidate (see FIG. 12 for a more detailed description). The user may request up to a certain level of the data to be consolidated or specify not to consolidate the data. Alternatively, configuration of the consolidation may be restricted to turning on and off the consolidation.

At step 172, the system 100 asynchronously returns an individual result set, as it is consolidated, to the user interface 128 for display.

At step 174, the user interface 128 configures the data to a certain a configured output format as defined by a display information file 180 for display on a user interface screen (i.e., window). Based on the display information file 180, the system 100 converts the query response data into an easily understood user interface presentation for interaction with the user by using the display information file 180.

At step 176, the user interface 128 displays the information to the user.

At step 178, the user interface 128 provides the system 100 or user with various available actions, via the information displayed at step 176.

At step 182, the user interface 128 responds to an action selected by the user or the system 100.

At step 184, the user interface 128 provides the selected information, along with the session ID 142, to the application 122 and/or server 123, via the AP interface 126 and the corresponding AP plug-ins 136. As an alternative to the AP Interface 126, a user is able to query the user interface 128 for the currently selected item and information within that item. The information within the item enables application 122 to perform specialized actions, such as communicate with the SOA adaptor 124. SOA adaptor (mediator) 124 performs a mediation function.

The system 100 has an open architecture that is easy to extend. The data service collector 110 supports a set of pre-defined view types, including major view types that are most frequently used.

Alternatively, the system employs dynamic view types so the users may create a customized view type. The system 100 enables a user to define a view type. After a user defines a new view type, the data service collector 110 dynamically detects information about the new view type, and starts to use it without any modification of data service collector 110.

The system 100 permits a user to define an individual view type by a set of XML schema definition (XSD) files, for example. When XML is chosen as the data query format, and the XML schema definition (XSD) language enables the definition of the structure and data types of XML documents, the XML Schema is used to define an individual view type, by specifying an individual view type's master criteria set and master query response data query response data. Similarly, when XML is the data output format, the system 100 uses XSD language so the same set of XSD files are used on both the input query and the output data side.

The system 100 permits XML schemas defining a view type to be accessible from both data collector service 110 and any SOA adapter 112 that supports this view type. At step 166, the SOA adapter 112 needs to validate the input XML query against these XML schemas before actually performing the query, and the data collector service 110 needs to validate the XML data output against same XML schemas before further processing by the results consolidator by the data output.

In order for the view type definitions to share a common structure, taking advantage of the extensible nature of XSD, the view type specific XML Schemas extend from one common base XML schema. For example, the system 100 describes an individual view type by a set of three or four XSD files. A master criteria set consists of two parts: preferred criteria and optional criteria, as provided by the following examples.

1) (Preferred) Base XSD that is common to view types.

2) (Preferred) Extension XSD defining the preferred criteria of a specific view type.

3) (Optional) Extension XSD defining the optional criteria of a specific view type.

4) (Preferred) Extension XSD defining the master query response data t of a specific view type.

For example, a simplified patient list view type can be defined by the following set of XSD files:

1) CINBaseViewType.xsd (Base XSD)

2). CINPatientListViewType-PreferredCriteria.xsd (preferred criteria XSD)

3) CINPatientListViewType-ReturnFields.xsd (master query response data XSD)

The system 100 supports a dynamic view type by providing dynamic user interface generation capability to the user interface 128 and by standardizing the SOA adapters 112.

When a new view type is added to the system 100, deployment and setup steps are performed. Because a new or existing SOA adapter 112 may support the new view type, the new adapter 112 needs to be added to the system 100, and existing adapter(s) 112 supporting the new view type need to be updated. In addition, the XML schema set defining the new view type need to be added to the configuration systems of both the user interface 128 and the corresponding SOA adapter(s) 112. Shutdown and restart of the user interface 128 should not be necessary in the addition of new view types.

The system 100 uses the display information file 180 to construct the user interface configuration of a new view type. Use of the new view type by the user interface comprises creating new query configuration and display information and passing the information to the user interface 128.

The system 100 also employs standardized SOA adapters 112. The system 100 employs SOA adapters 112 as web services (e.g., XML), for example, that communicate with one or more of the data sources 134. The web services provided by SOA adapter 112 exposes web methods in accordance with the data source interface 132 allowing the data collector service 110 to retrieve supporting view types and execute an XML query. An additional web method allows the data collector service 110 to properly identify the data source 134 and report to the user the data sources 134 being queried. Three web methods include three methods having the following characteristics.

1. [WebMethod(Description=“Retrieve an array of ViewType objects supported by this SOA Service. An individual ViewType object contains Name and Version information of the View Type.”)]
public ViewType[ ] GetSupportingViewTypes( )

2. [WebMethod(Description=“Execute an XML query and output query result in an XML string.”)]
public System.Xml.XmlDocument ExecuteQuery(string viewTypeName, string viewTypeVersion, string xmlQuery, int maxReturnRows)

3. [WebMethod(Description=“Returns the name, description, and IP address of the Data Source attached to the SOA Adapter.”)]
public System.Xml.XmlDocument GetDataSource( )

The ExecuteQuery process, having the characteristics above, takes the view type information and an input XML query string 158, validates 160 the XML query string against the XML schemas required by this view type, queries 162 the data source 134 given the criteria and query response data, and packages result data into an XML result string 164 for processing 170 and display 174 and 176. If any errors occurred within the data collector service 110, the XML result string 164 have a root node of <Error>, and the information regarding the error appears inside the node.

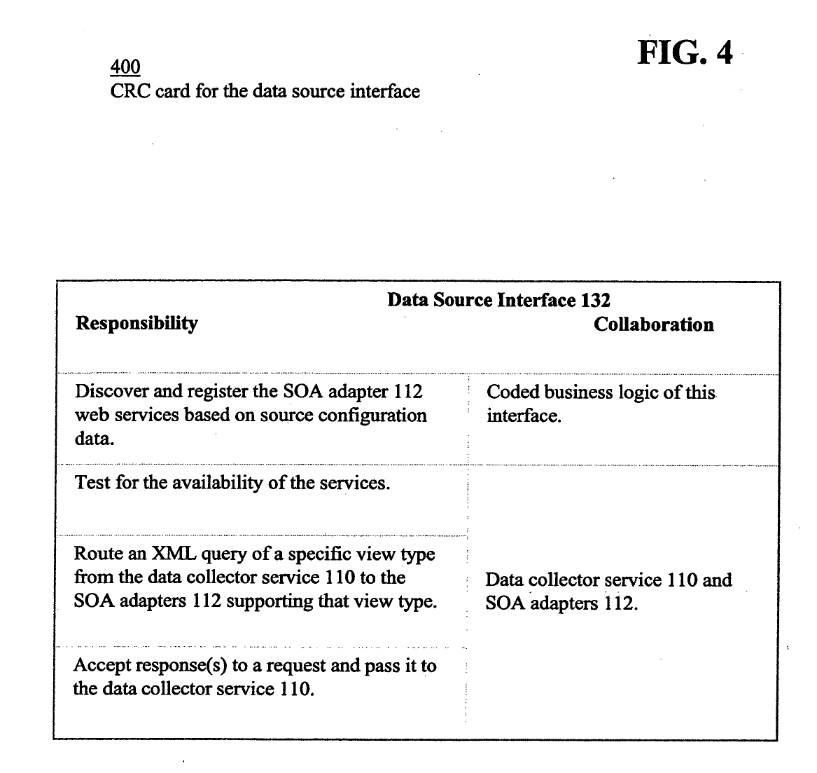

FIGS. 4-8 illustrate various class responsibility collaboration (CRC) cards for various classes (i.e., elements) of the system 100. CRC cards are brainstorming tools used in the design of object-oriented software. They are typically used when first determining which classes are needed and how they interact. CRC cards are usually created from index cards on which are written: the class name, the responsibilities of the class, and the names of other classes that the class collaborates with to fulfill its responsibilities.

A class represents a collection of similar objects. An object is a person, place, thing, event, or concept that is relevant to the system at hand. A responsibility is anything that a class knows or does. Sometimes a class has a responsibility to fulfill, but not have enough information to do it, and, therefore, needs to collaborate with other classes.

Using a small card keeps the complexity of the design at a minimum. It focuses attention on the essentials of the class and prevents diversion of attention to detail when such detail is probably counter-productive. It also prevents a class from having too many responsibilities, for example.

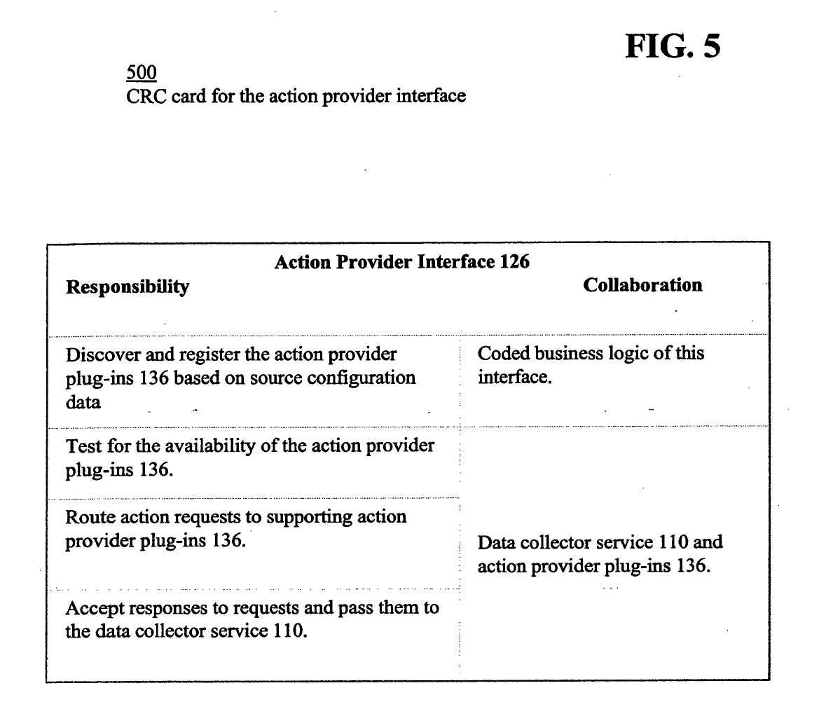

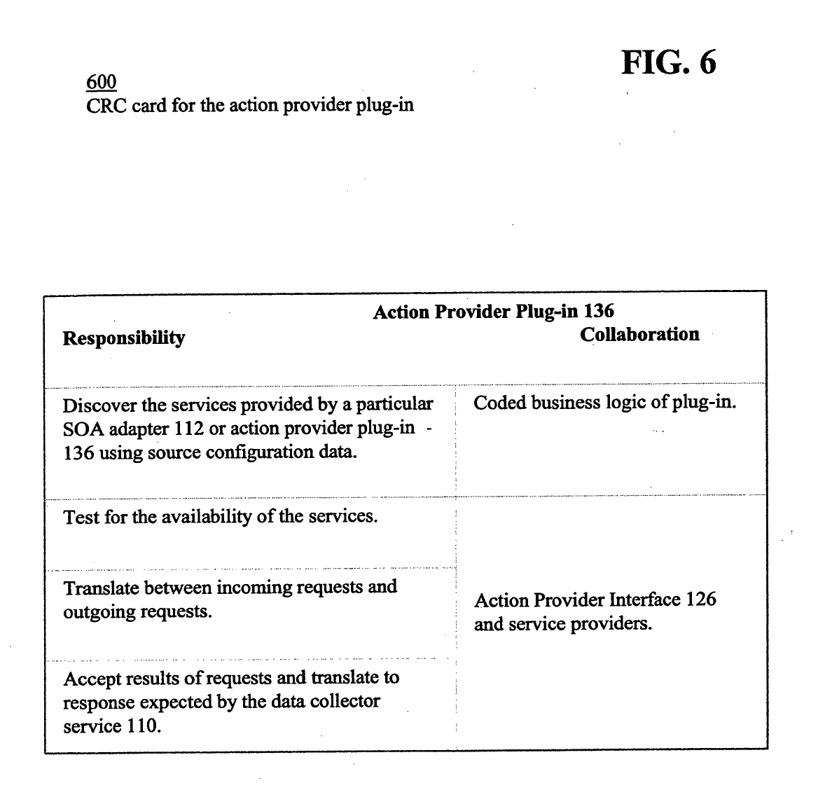

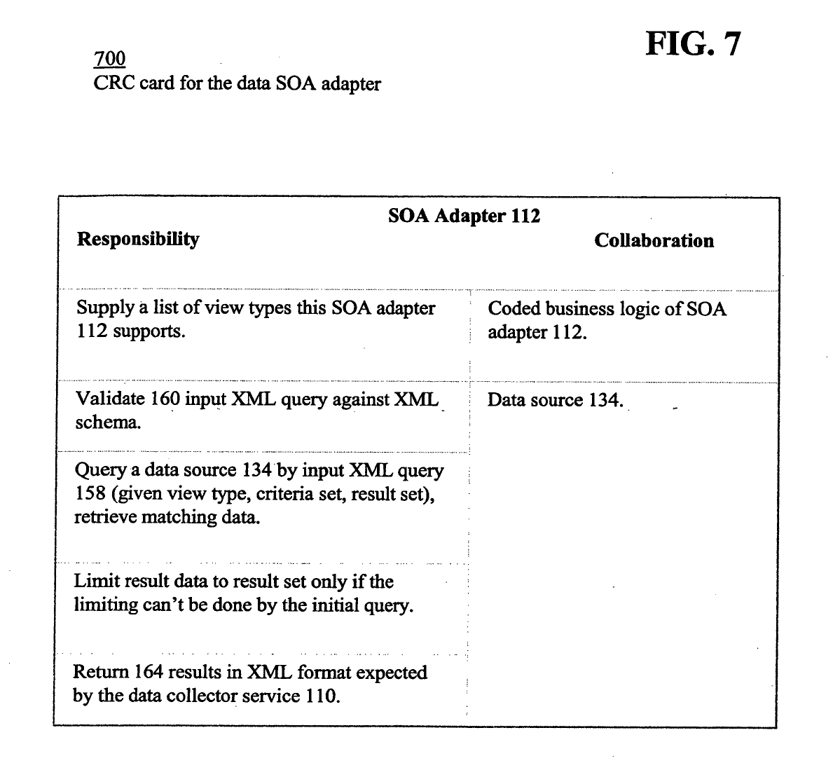

FIG. 4 illustrates a CRC card for data source interface 132. FIG. 5 illustrates a CRC card for action provider interface 126. FIG. 6 illustrates a CRC card for action provider plug-ins 136. FIG. 7 illustrates a CRC card for SOA adapters 112. FIG. 8 illustrates a CRC card for results consolidator 168.

In FIG. 7, component properties include the following:

1. Services exposed reflect the functional capabilities of the data source 134.

2. Services exposed in a lightweight Web friendly manner.

3. Services are discoverable.

In FIG. 8, component properties include the following:

1. A unique identifier (a set of fields) is determined for an individual view type in order to eliminate duplicates.

2. The set of fields for uniqueness identification needs to be defined in the return fields XSD of that particular view type.

3. The consolidated query response data are sent with a clear indicator to inform the display generator 174 whether there are still results pending, or results have arrived.

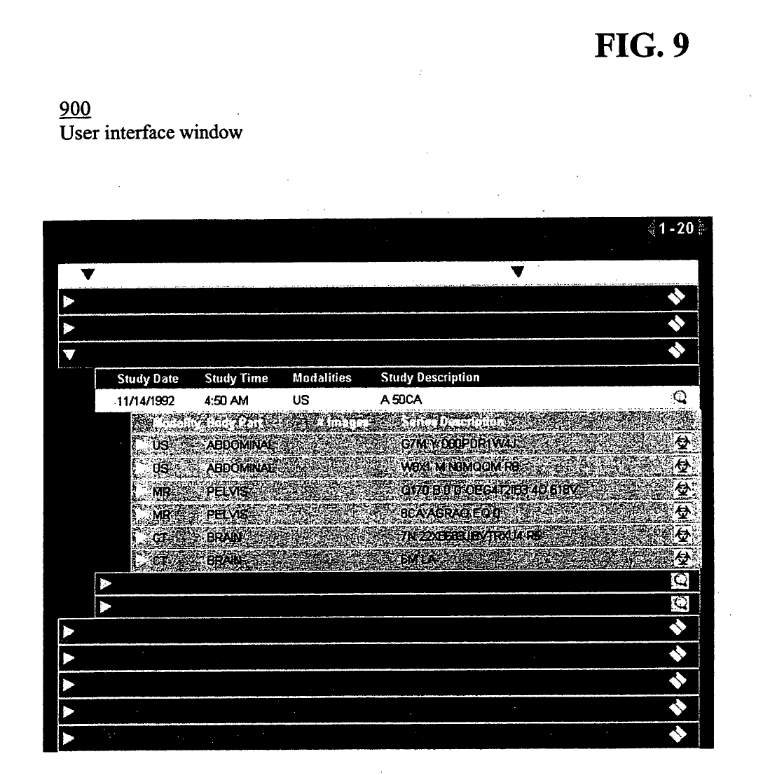

FIG. 9 illustrates a user interface window 900 generated from a generic display configuration. The window 900 generally includes four columns, for example, including a patient identification (ID), the patient name, a date of birth (DoB) of the patient, and the gender of the patient.

A user may expand a particular patient's information (such as by clicking on an icon or anywhere in the row of patient information) to display four additional columns, for example, including a study date, a study time, modalities, and a study description.

A user may expand a particular study (such as by clicking on an icon or anywhere in the row of patient information) to display four additional columns, for example, including modality, body part, number of images, and a series description.

The system 100 identifies a user's request to expand information in the user interface window 900 at one or more levels as a sub-query. The high level information displayed represents the results for the user's query.

The expanded detailed level information displayed represents the results for the user's sub-query. Any number of sub-queries are possible, but may be limited by the availability of corresponding information content.

The icons on the right side of the rows of information provide links to detailed reports and images, for example.

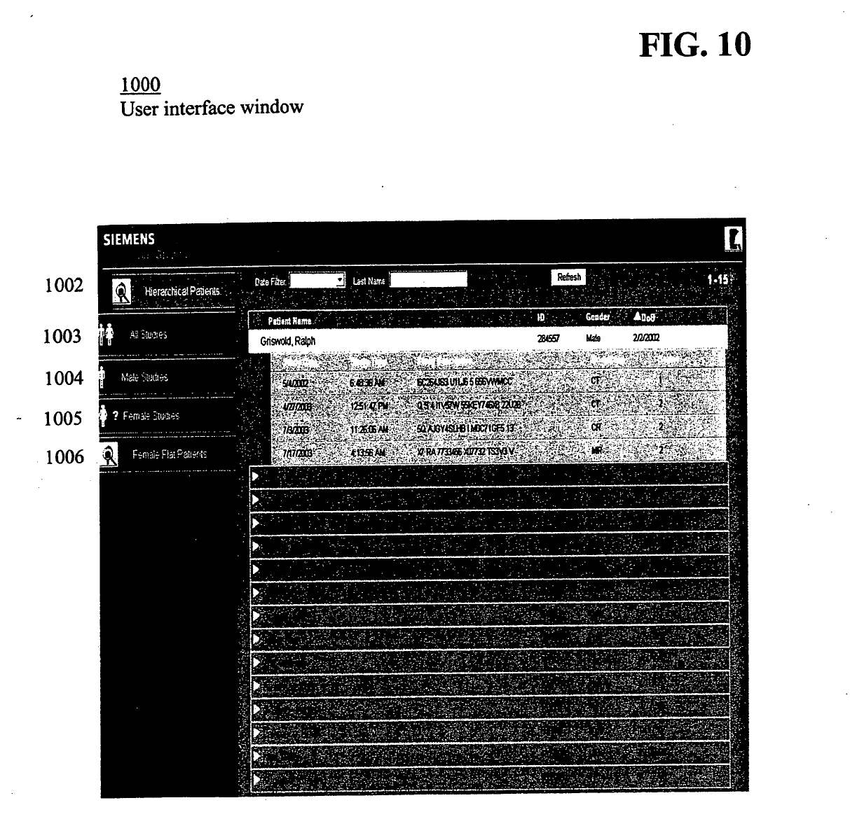

FIG. 10 illustrates user interface window 1000, as shown in FIG. 9, combined into another generic user interface configuration to provide a higher level display. The window 1000 includes, for example, a hierarchical list of patients 1002 that may be searched and displayed by date or last name, for example, a list of all studies 1003, a list of male studies 1004, a list of female studies 1005, and a list of female flat patients 1006. The lists of patients and/or studies 1002-1006 may also be referred to as Tab Worklists.

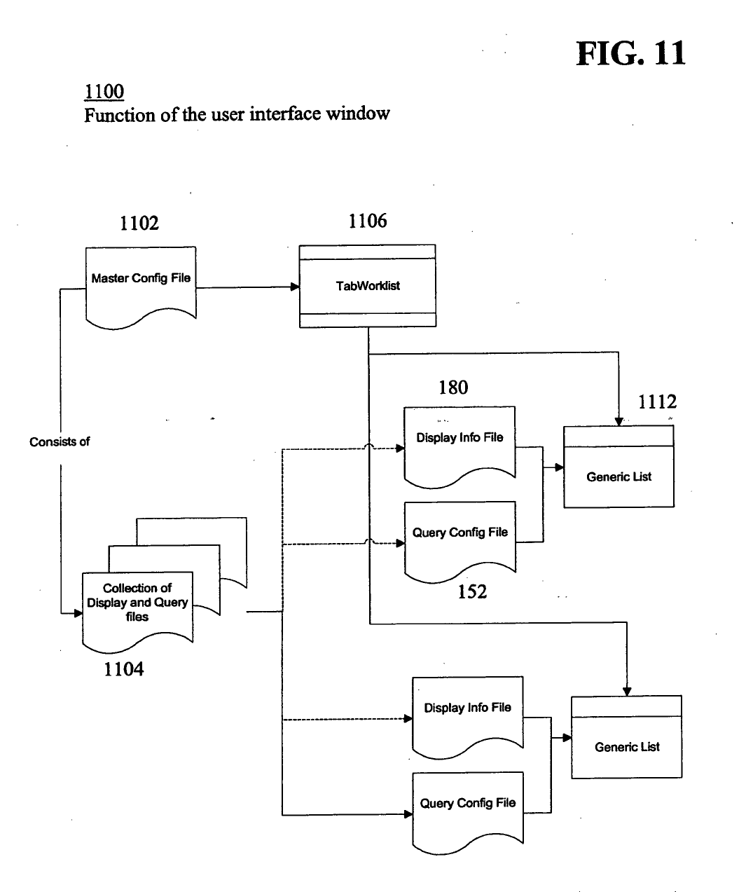

FIG. 11 illustrates a function of the Tab Worklist 1002-1006 in the user interface window 1000 to configure the user interface window 1000, as shown in FIG. 10. FIG. 11 illustrates interaction of the query configuration file 152 and the display configuration file 180 used to display the results of the query 154 using a generic display list to display the user interface window 1000, for example, as shown in FIG. 10.

The system 100 stores a master configuration file 1102, which includes a collection of the query configuration files 152 (also shown in FIG. 3) and the display information files 180 (also shown in FIG. 3). FIG. 11 illustrates the query configuration files 152 and the display information files 180 by reference number 1104.

The query configuration files 152 correspond to the nature or topic of the desired information (e.g., header information, such as patient name, ID, gender, and date of birth, shown in FIG. 10). The desired information represents the content of the information desired by the requesting user. The display information files 180 correspond to the display format of the desired information (e.g., arranging header information, such as the patient name, the ID, the gender, and the date of birth in a row positioned in a user interface window, shown in FIG. 10). Therefore, the two files 152 and 180 provide the nature and the format of the desired information.

The system 100 sends the master configuration file 1102 to the Tab Worklist element 106. The Tab Worklist element 106 receives the master configuration file 1102 and processes the master configuration file 1102 to produce multiple generic lists 1112. A generic list 1112 represents the nature and the format of the desired information represented by the two files 152 and 180. The system 100 uses the multiple generic lists 1112 to configure the display, layout, and query, for example. Next, FIGS. 12 and 13 illustrate a method for processing the received queries 164 to determine the content of the desire information (e.g., Griswold, Ralph, 284557, Male, and Feb. 2, 2002, shown in FIG. 10).

FIG. 12 illustrates a method 1200 performed by the results consolidator 168 to process multiple received asynchronous query results 164 (i.e., content of the desired information) for presentation in the user interface window 1000, for example, shown in FIG. 10.

At step 1202, the method 1200 starts.

At step 1203, the results consolidator 168 determines whether the data received from the data source interface 132 is the first instance of a return of data for the corresponding query. If the determination at step 1203 is positive, the method 1200 continues to step 1204; otherwise, if the determination at step 1203 is negative, the method 1200 continues to step 1206.

At step 1204, the results consolidator 168 adds the received data to a table (e.g., “hash table”), for example. Other methods of consolidation and updating the content of the desired data may also be used.

A hash table is an associative array data structure that associates keys with values. The primary operation it supports efficiently is a lookup, where it is given a key, which is an identifier for the information to be found, such as a person's name, and asked to find the corresponding value. The hash table works by transforming the key using a hash function into a hash, which is a number that the hash table uses to locate the desired value.

The associative array data structure is map, lookup table, or dictionary, is an abstract data type very closely related to the mathematical concept of a function with a finite domain.

The data structure is a way of storing data in a computer so that it can be used efficiently. Often, a carefully chosen data structure allows a more efficient algorithm to be used. Examples of data structures include trees, which function well with data bases as in the present system 100, and routing tables, which rely on networks of machines to function.

A hash function is a function that converts an input from a typically large domain into an output in a typically smaller range. Hash functions vary in the domain of their inputs and the range of their outputs, and in how patterns and similarities of input data affect output data.

At step 1205, the results consolidator 168 formats the received data in XML format, for example.

At step 1206, the results consolidator 168 checks the most recently received data at two levels, for example, of the tree when the data received from the data source interface 132 is not the first instance of a return of data for the corresponding query.

At step 1207, the results consolidator 168 divides the most recently received data into multiple nodes of the tree to provide efficient processing the received data.

At step 1208, the results consolidator 168 determines for an individual node of the tree whether the consolidator field is empty. If the determination at step 1208 is positive, the method 1200 continues to step 1209; otherwise, if the determination at step 1208 is negative, the method 1200 continues to step 1212. A positive determination at step 1208 indicates that there are no more levels of the tree to check. A negative determination at step 1208 indicates that there are more levels of the tree to check.

At step 1209, the results consolidator 168 appends the most recently received data to the table mentioned in step 1204.

At step 1210, the results consolidator 168 formats the most recently received data in XML format, for example. The method 1200 continues to step 1211.

At step 1211, the results consolidator 168 provides the most recently received data in XML format to the display generator 174 to display the information 176 in a user interface window 900 or 1000, for example, as shown in FIGS. 9 and 10, respectively.

At step 1212, the results consolidator 168 creates a hash key.

At step 1213, the results consolidator 168 determines whether the hash key is in the table mentioned in step 1204. If the determination at step 1213 is positive, the method 1200 continues to step 1214; otherwise, if the determination at step 1213 is negative, the method 1200 continues to step 1216. A positive determination at step 1213 indicates that another level of received data needs to be processed. A negative determination at step 1213 indicates that no other level of received data needs to be processed.

At step 1214, the results consolidator 168 retrieves data indicating data source priority.

At step 1215, the results consolidator 168 copies leaves of the tree from a higher priority, and returns to step 1206 to check the next level of received data.

At step 1216, the results consolidator 168 adds the hash key to the table mentioned in steps 1204 and 1209.

At step 1217, the results consolidator 168 appends the most recently received data to the table mentioned in step 1204.

At step 1218, the results consolidator 168 formats the most recently received data in XML format, for example. The method 1200 continues to step 1211.

FIG. 13 illustrates a method 1300 for processing sub-queries. The system 100 may be flexibly extended and adapted to site realities, without requiring code changes and recompilation. Dynamically created sub-queries, providing additional performance even when considering large collections of data, are also configured into the definition of the data view types. FIG. 9 shows examples of sub-queries. Other method of processing sub-queries may be implemented in the system 100.

At step 1302, the system 100 presents a generic list 1112, as provided by the method 1100 in FIG. 11, including: a paging bar (e.g., 1002-1006) having header information for rows of information retrieved from the data sources 134, as shown in FIGS. 9 and 10.

FIG. 13 illustrates multiple groups of steps 1303-1310, wherein an individual group of steps are performed by the system 100 when a user selects an individual row of information to expand to generate a sub-query. In other words, a sub-query is limited to the group of information to be searched. For example, in FIG. 9, a named patient, represents a group of information for that patient, which may be further expanded into various studies for that patient, and various results of individual studies.

At step 1303, the system 100 receives an indication from a user that a user initiated a request for a sub-query. A user may initiate an indication, for example, by clicking on an icon or a row of information, or by entering a command.

At step 1304, the system 100 provides the user feedback to the user of the user's indication that the user initiated a request for a sub-query. The system 100 provides the user feedback by, for example, highlighting the icon or the row of information that the user clicked on.

At step 1305, the system 100 initiates a request for the sub-query (e.g., “Squid query”).

At step 1306, the system 100 receives the information corresponding to the requested sub-query, otherwise called a “callback” function. A callback is executable code that is passed as a parameter to other code. The callback allows a low level software layer to call a function occurring in a higher level layer. Usually the higher level code first calls a function within the lower level code passing to it a pointer or handle to another function. Then, the lower level function in the course of executing may call the passed-in function any number of times to perform some subtask.

At step 1307, the system 100 updates the user interface display with the information corresponding to the requested sub-query, via the display generator 174 and the display 176.

At step 1308, the system 100 determines whether there is more the information corresponding to the requested sub-query to display. If the determination at step 1308 is positive, the method 1300 continues to step 1309; otherwise, if the determination at step 1308 is negative, the method 1300 continues to step 1310.

The data may be displayed in various ways, depending on various considerations, for example, system design, user preference, location of data sources, etc. For example, the data may be displayed in a piecemeal fashion, either organized or random, when received and processed. The data may be displayed in a group fashion, either organized or random, when groups of relevant data are received and processed (e.g., data from the same data source). The data may be displayed after all of the data corresponding to the query or sub-query has been received and processed.

At step 1309, the system 100 request additional information corresponding to the requested sub-queries that has not yet been displayed so that the information may be displayed. The method 1300 continues to step 1306 to check if additional data has been received.

At step 1310, the system 100 continues with other processing, upon determining that all of the information corresponding to the requested sub-query has been displayed.

At step 1311, the system 100 begins the request for the sub-query.

At step 1312, the system 100 initiates a session corresponding to the request for the sub-query.

At step 1313, the system 100 executes the session corresponding to the request for the sub-query.

At step 1314, the system 100 queues the requests for the sub-query, for example, when there are more than one request or when the system 100 cannot process multiple requests fast enough.

At step 1315, the system 100 retrieves a document (e.g., in XML format) having information corresponding to the requests for the sub-query. The document may reside in the system 100 or may reside in one or more of the data sources 134.

At step 1316, the system 100 generates a callback for the XML document having information corresponding to the requests for the sub-query.

At step 1317, the system 100 retrieves the information corresponding to the requests for the sub-query from the XML document.

At step 1318, the system 100 waits for a pulse response generated by steps 1319-1322. A purpose of the pulse response is to wait for consolidation of the information corresponding to the requests for the sub-query before updating the display with the additional information. Other methods of consolidation and timing are also available and should not be limited to the present embodiment.

At step 1319, the system 100 sends a request for the information corresponding to the requests for the sub-query.

At step 1320, the system 100 receives a response (e.g., callback) from the data sources 134 including the additional requested information.

At step 1321, the system 100 consolidates the responses from the data sources 134.

At step 1322, the system 100 generates the pulse response for step 1318 indicating that the one or more data sources 134 have responded.

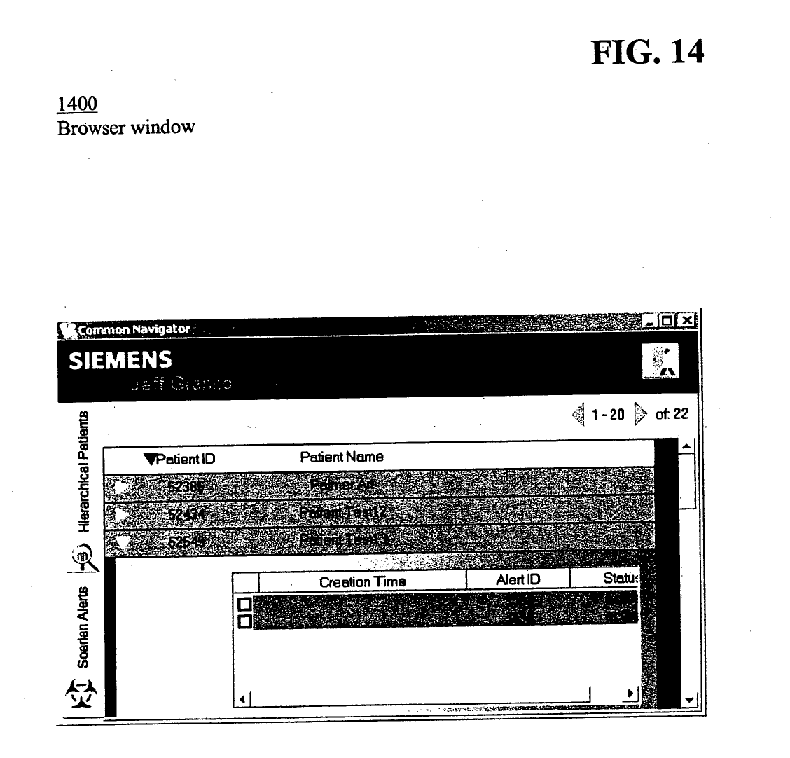

FIG. 14 illustrates a browser window 1400 incorporating the user interface windows 900 and/or 1000, as shown in FIGS. 9 and/or 10. The system 100 describes data types so that the information may be collected in a generic way, without any specific coding, and is extensible to multiple information technology applications. The system 100 describes information to be collected through the configuration of data types and the dynamic collection of consolidation of information. The system 100 incorporates the user interface components 128 into a single integrated browser application in which a single application provides a presentation of data from the data sources 134. The user employs a browser as a portal to find the data upon which they need to operate. Alternatively, the system 100 may employ the user interface components 128 in a stand-alone manner, outside of a browser application.

### EXAMPLE

A simplified example of operation of the system 100 is described next. The example is simplified because the example omits the actual display components which control sub-queries and actual parse display configuration files in order to know how to generate the displays.

1. A user generates 150 a query 154 in a first data format of a particular view type 146 with specified criteria 148 (see FIG. 3).

2. The data collector service 110 validates 160 the request based on its knowledge of the view type supplied by the configuration of the view type.

```
<?xml version=“1.0” encoding=“ISO-8859-1” ?>
<xs:schema xmlns:xs=“http://www.w3.org/2001/XMLSchema”
targetNamespace=“xsdCINReturnFields” xmlns=“xsdCINReturnFields”
elementFormDefault=“qualified”>
  <xs:element name=“Patient” type=“patientType” />
  <xs:complexType name=“patientType”>
    <xs:sequence>
      <xs:element name=“Name” type=“xs:string” minOccurs=“0” />
      <xs:element name=“ID” type=“uidType” minOccurs=“0” />
      <xs:element name=“Gender” type=“genderValueType”
      minOccurs=“0” />
      <xs:element name=“Age” type=“xs:string” minOccurs=“0” />
      <xs:element name=“DOB” type=“xs:date” default=“1000-01-01”
      minOccurs=“0” />
    </xs:sequence>
  </xs:complexType>
  <xs:complexType name=“uidType”>
    <xs:simpleContent>
      <xs:extension base=“xs:string”>
        <xs:attribute name=“squid” type=“xs:boolean”
        use=“optional” />
      </xs:extension>
    </xs:simpleContent>
  </xs:complexType>
  <xs:simpleType name=“genderValueType”>
    <xs:restriction base=“xs:string”>
      <xs:pattern value=“Male|Female|Other|” />
    </xs:restriction>
  </xs:simpleType>
  <xs:complexType name=“consolidationType”>
    <xs:sequence>
      <xs:element name=“ConsolidationConfig” type=“xs:string”
minOccurs=“0” default=“rf:Patient,rf:ID” />
    </xs:sequence>
  </xs:complexType>
</xs:schema>
```

3. The data collector service 110 finds data sources 134 that support the specified view type 146, and asynchronously queries an individual data source 134 with the supplied criteria 148.

4. The data collector service 110 validates 166 and consolidates 168 the results and returns consolidated information to the requester asynchronously 164, if so requested.

The system 100 advantageously dynamically queries multiple data sources 134 for information of a given format, which is defined in selectable and comprehensive manner.

In order to support a new view type, the system 100 employs the following.

1. The display information file 180 (i.e., a view type configuration file) (e.g., shown in XML below) put into the data collector service 110 accessible directory.

2. The system 100 either expands SOA adapter 112 or creates a new SOA adapter 112 that supports the new view type. If the system 100 creates a new SOA adapter 112, then its presence is made known to the data collector service 110 via additions to a configuration file that holds “contact” information for all available SOA adapters 112.

The system 100 provides a display information file 180 (shown in FIG. 3) that describes how to display the new view type, as shown in the following example.

```
- <Display>
- <Imports>
  <Include type=“style”>styles/ahl.css</Include>
  </Imports>
- <Graphics>
  <Highlight color=“#ffffff” />
  <SortableImage src=“pics/sort.gif” />
  <SortedImage order=“ascending” src=“pics/sort_down.gif” />
  <SortedImage order=“descending” src=“pics/sort_up.gif” />
  <StateImage state=“expanded” src=“pics/expanded.gif” />
  <StateImage state=“collapsed” src=“pics/collapsed.gif” />
  <ScrollImage order=“left” src=“pics/arrow_left.gif” />
  <ScrollImage order=“right” src=“pics/arrow_right.gif” />
  </Graphics>
- <Header node=“rf:Patient” width=“95%”>
- <DisplayHeaders style=“topHeader”>
  <Column width=“15%” sort=“ascending” style=“white header”>Patient ID</Column>
  <Column width=“*” sort=“ascending” default=“true” style=“white header”>Patient
Name</Column>
  <Column width=“15%” sort=“descending” style=“white header”>DoB</Column>
  <Column width=“10%” style=“white header”>Sex</Column>
  <Column width=“5%” />
  </DisplayHeaders>
- <DataFields style=“patient” level=“patient”>
  <Field type=“data” name=“pid”>rf:ID</Field>
  <Field type=“data” name=“name”>rf:Name</Field>
  <Field type=“data” name=“dob” data-type=“date” format=“mm/dd/yy”>rf:DOB</Field>
  <Field type=“data” name=“gender”>rf:Gender</Field>
- <Field type=“action”>
  <Data type=“image”>pics/patient.gif</Data>
- <Action type=“http-get”>
  <Method>https://mlvv2ola.usmlvv1p0a.smshsc.net/MagicWeb/oemquery.asp</Method>
  <Param name=“us” type=“text”>jgranito</Param>
  <Param name=“is” type=“text”>y</Param>
  <Param name=“pi” type=“data”>rf:ID</Param>
  </Action>
  </Field>
  </DataFields>
  </Header>
- <Header node=“rf:Study” width=“90%”>
- <DisplayHeaders style=“study header”>
  <Column width=“15%” sort=“ascending”>Study Date</Column>
  <Column width=“15%” sort=“descending”>Study Time</Column>
  <Column width=“15%”>Modalities</Column>
  <Column width=“*”>Study Description</Column>
  <Column width=“5%” />
  </DisplayHeaders>
- <DataFields style=“study” level=“study”>
  <Field type=“data” name=“date” data-type=“date” format=“short”>rf:StudyDate</Field>
  <Field type=“data” name=“time” data-type=“time” format=“long”>rf:StudyTime</Field>
  <Field type=“data” name=“mod”>rf:ModalitiesInStudy</Field>
  <Field type=“data” name=“desc”>rf:StudyDescription</Field>
- <Field type=“action”>
  <Data type=“image”>pics/study.jpg</Data>
- <Action type=“http-get”>
  <Method>https://mlvv2o1a.usmlvv1p0a.smshsc.net/MagicWeb/oemquery.asp</Method>
  <Param name=“us” type=“text”>jgranito</Param>
  <Param name=“is” type=“text”>y</Param>
  <Param name=“pi” type=“data”>ancestor::rf:Patient/rf:ID</Param>
  <Param name=“si” type=“data”>rf:StudyID</Param>
  </Action>
  </Field>
  </DataFields>
  </Header>
- <Header node=“rf:Series” width=“85%”>
- <DisplayHeaders style=“series header”>
  <Column width=“10%”>Modality</Column>
  <Column width=“20%”>Body Part</Column>
  <Column width=“15%”># Images</Column>
  <Column width=“*”>Series Description</Column>
  <Column width=“5%”/>
  </DisplayHeaders>
- <DataFields style=“series” level=“series”>
  <Field type=“data” name=“mod”>rf:Modality</Field>
  <Field type=“data” name=“body”>rf:BodyPartExamined</Field>
  <Field type=“data” name=“imgs”>rf:NumOfImages</Field>
  <Field type=“data” name=“desc”>rf:SeriesDescription</Field>
- <Field type=“action”>
  <Data type=“image”>pics/bio.gif</Data>
- <Action type=“http-get”>
  <Method>https://mlvv2o1a.usmlvv1p0a.smshsc.net/MagicWeb/oemquery.asp</Method>
  <Param name=“us” type=“text”>jgranito</Param>
  <Param name=“is” type=“text”>y</Param>
  <Param name=“pi” type=“data”>ancestor::rf:Patient/rf:ID</Param>
  <Param name=“si” type=“data”>ancestor::rf:Study/rf:StudyID</Param>
  <Param name=“sm” type=“data”>rf:Modality</Param>
  </Action>
  </Field>
  </DataFields>
  </Header>
- <Header node=“rf:Image” width=“80%”>
- <DisplayHeaders style=“image header”>
  <Column width=“*”>Image ID</Column>
  <Column width=“25%” sort=“ascending”>Image Date</Column>
  <Column width=“25%” sort=“descending”>Image Time</Column>
  </DisplayHeaders>
- <DataFields style=“image” level=“image”>
  <Field type=“data” name=“iid”>rf:ImageID</Field>
  <Field type=“data” name=“date” data-type=“date” format=“short”>rf:ImageDate</Field>
  <Field type=“data” name=“time” data-type=“time” format=“long”>rf:ImageTime</Field>
  </DataFields>
  </Header>
  </Display>
```

The system 100 provides the ability for the data collector service 110 to dynamically query multiple data sources 134 for information of a given format, which is defined in an abstract manner. This technique allows the data collector service 110 and the data source 134 to exchange data with only an abstract descriptive meta-language, as a pre-defined contract, in a meaningful manner. Hence, information is collected from potentially multiple data sources 134, organized 168, and then presented 174 and 176 to an end-user in a meaningful way. The user can trigger arbitrary actions on selected information, and can view the results of an action, without requiring any custom programming specifically for the type of information being displayed.

While the present invention has been described with reference to various illustrative embodiments thereof, the present invention is not intended that the invention be limited to these specific embodiments. Those skilled in the art recognize that variations, modifications, and combinations of the disclosed subject matter can be made without departing from the spirit and scope of the invention as set forth in the appended claims.

What is claimed is:

1. A system for acquiring and processing data from a plurality of different data sources, comprising:
a first source of predetermined configuration information for associating a received query for information in a first data format with,
a corresponding particular structured data request format and
a plurality of different data sources;
a second source of predetermined configuration information for associating said particular structured data request format with a plurality of different data sources; and
a query processor for using said first and second source of predetermined configuration information for translating said received query for information in said first data format to a plurality of queries in different data formats for communication to said plurality of different data sources.

2. A system according to claim 1, wherein
said particular structured data request format includes associated ancillary data for use in processing data elements, in query reply messages received in response to said plurality of queries communicated to said plurality of different data sources, by at least one of, (a) eliminating redundant replicated data elements and (b) substituting a first received data element for a second received data element.

3. A system according to claim 2, wherein
said query processor substitutes said first received data element for said second received data element in response to information indicating a predetermined priority of said plurality of different data sources.

4. A system according to claim 1, wherein
said particular structured data request format includes associated ancillary data for use in sorting data elements, in query reply messages received in response to said plurality of queries communicated to said plurality of different data sources, said sorting being performed in response to at least one of, (a) user command received via a displayed user interface image and (b) automatically, based on predetermined configuration information.

5. A system according to claim 1, wherein
said particular structured data request format includes associated ancillary data for use by said query processor in dividing said received query into a plurality of sub-queries for communication to said plurality of different data sources.

6. A system according to claim 5, wherein
said query processor, in response to said ancillary data, communicates a first set of selected sub-queries of said plurality of sub-queries to a first source of said plurality of different data sources and a different second set of selected sub-queries of said plurality of sub-queries to a second source of said plurality of different data sources.

7. A system according to claim 5, wherein
said query processor, in response to said ancillary data, communicates a common set of selected sub-queries of said plurality of sub-queries to said plurality of different data sources.

8. A system according to claim 1, wherein
said particular structured data request format includes associated ancillary data for use in formatting for display, data elements received in query reply messages received in response to said plurality of queries communicated to said plurality of different data sources.

9. A system according to claim 1, wherein
said query processor initiates communication of said plurality of queries in different data formats together with session information, said session information identifying a user initiating said received query and being usable by a data source in determining whether said user is authorized to receive requested information.

10. A system for acquiring and processing data from a plurality of different data sources, comprising:
a first source of predetermined configuration information for associating a received query for information in a first data format with,
a corresponding particular structured data request format and
a plurality of different data sources;
a second source of predetermined configuration information for associating said particular structured data request format with,
a plurality of different data sources and
corresponding communication protocols used for interrogating said plurality of different data sources; and
a query processor for using said first and second source of predetermined configuration information for translating said received query for information in said first data format to a plurality of queries in different data formats for communication using said corresponding communication protocols to said plurality of different data sources.

11. A system according to claim 10, wherein
said particular structured data request format includes associated ancillary data for use in processing data elements, in query reply messages received in response to said plurality of queries communicated to said plurality of different data sources, by at least one of, (a) eliminating redundant replicated data elements and (b) substituting a first received data element for a second received data element.

12. A system according to claim 11, wherein
said query processor substitutes said first received data element for said second received data element in response to information indicating a predetermined priority of said plurality of different data sources.

13. A system according to claim 10, wherein
said particular structured data request format includes associated ancillary data for use in sorting data elements, in query reply messages received in response to said plurality of queries communicated to said plurality of different data sources, said sorting being performed in response to at least one of, (a) user command received via a displayed user interface image and (b) automatically, based on predetermined configuration information.

14. A system according to claim 10, wherein
said particular structured data request format includes associated ancillary data for use by said query processor in dividing said received query into a plurality of sub-queries for communication to said plurality of different data sources.

15. A system according to claim 14, wherein
said query processor, in response to said ancillary data, communicates a first set of selected sub-queries of said plurality of sub-queries to a first source of said plurality of different data sources and a different second set of selected sub-queries of said plurality of sub-queries to a second source of said plurality of different data sources.

16. A system according to claim 14, wherein
said query processor, in response to said ancillary data, communicates a common set of selected sub-queries of said plurality of sub-queries to said plurality of different data sources.

17. A system according to claim 10, wherein
said particular structured data request format includes associated ancillary data for use in formatting for display, data elements received in query reply messages received in response to said plurality of queries communicated to said plurality of different data sources.

18. A system according to claim 10, wherein
said particular structured data request format comprises a plurality of predetermined data fields in a particular structure for accommodating a corresponding plurality of data elements.

19. A system according to claim 18, wherein
said particular structured data request format is structured to be compatible with a structured programming language comprising at least one of, (a) XML, (b) SGML and (c) HTML.

20. A system according to claim 10, including
a data processor for receiving query reply messages in response to said plurality of queries communicated to said plurality of different data sources and for collating data in said query reply messages in a desired format in response to said particular structured data request format.

21. A system according to claim 10, including
a data processor for receiving query reply messages in response to said plurality of queries communicated to said plurality of different data sources and for collating data in said query reply messages in a desired format in response to said received query.

22. A system according to claim 10, wherein
said query processor parses and examines said plurality of queries in said different data formats to determine whether individual queries are compatible with corresponding destination data sources.

23. A system according to claim 22, wherein
said query processor determines whether individual queries are compatible with corresponding destination data sources by determining whether said individual queries are semantically correct.

24. A system according to claim 10, wherein
said query processor translates said received query for information in said first data format to said plurality of queries in different data formats by translating said received query into a different data format having a syntax compatible with a communication interface of a data source.

25. A system according to claim 10, wherein
said first and second source of predetermined configuration information are the same source.

26. A system for acquiring and processing data from a plurality of different data sources, comprising:
a first source of predetermined configuration information, for associating a received query for information in a first data format with,
a corresponding particular structured data request format including associated ancillary data and
a plurality of different data sources;
a second source of predetermined configuration information for associating said particular structured data request format with,
a plurality of different data sources and
corresponding communication protocols used for interrogating said plurality of different data sources; and
a query processor for,
using said first and second source of predetermined configuration information for translating said received query for information in said first data format to a plurality of queries in different data formats for communication using said corresponding communication protocols to said plurality of different data sources and
using said ancillary data in processing data elements, in query reply messages received in response to said plurality of queries communicated to said plurality of different data sources.

27. A system for acquiring and processing data from a plurality of different data sources, comprising:
a first source of predetermined configuration information for associating a received query for information in a first data format with,
a corresponding particular structured data request format including associated ancillary data and
a plurality of different data sources;
a second source of predetermined configuration information for associating said particular structured data request format with a plurality of different data sources;
a query processor for using said first and second source of predetermined configuration information for translating said received query for information in said first data format to a plurality of queries in different data formats for communication to said plurality of different data sources; and
a data processor for receiving query reply messages in response to said plurality of queries communicated to said plurality of different data sources and for collating data in said query reply messages in a desired format in response to said ancillary data.

28. A system according to claim 27, wherein
said query processor uses said ancillary data in dividing said received query into a plurality of sub-queries for communication to said plurality of different data sources.

29. A system according to claim 27, wherein
said query processor uses said ancillary data in processing data elements in said query reply messages, by at least one of, (a) eliminating redundant replicated data elements and (b) substituting a first received data element for a second received data element.

30. A system according to claim 27, wherein
said ancillary data comprises meta data of said particular structured data request format.

31. A method for acquiring and processing data from a plurality of different data sources, comprising the activities of:
associating a received query for information in a first data format with,
a corresponding particular structured data request format and
a plurality of different data sources, to provide first predetermined configuration information;
associating said particular structured data request format with,
a plurality of different data sources and
corresponding communication protocols used for interrogating said plurality of different data sources, to provide second predetermined configuration information; and
using said first and second predetermined configuration information for translating said received query for information in said first data format to a plurality of queries in different data formats for communication using said corresponding communication protocols to said plurality of different data sources.

32. A method according to claim 31, comprising
implementing said method in an executable application embodied in a tangible storage medium.

33. A method for acquiring and processing data from a plurality of different data sources, comprising the activities of:
associating a received query for information in a first data format with,
a corresponding particular structured data request format including associated ancillary data and
a plurality of different data sources, to provide first predetermined configuration information;
associating said particular structured data request format with,
a plurality of different data sources and
corresponding communication protocols used for interrogating said plurality of different data sources, to provide second predetermined configuration information; and
using said first and second predetermined configuration information for translating said received query for information in said first data format to a plurality of queries in different data formats for communication using said corresponding communication protocols to said plurality of different data sources and
using said ancillary data in processing data elements, in query reply messages received in response to said plurality of queries communicated to said plurality of different data sources.

34. A method according to claim 33, comprising
implementing said method in an executable application embodied in a tangible storage medium.

35. A method for acquiring and processing data from a plurality of different data sources, comprising the activities of:
associating a received query for information in a first data format with,
a corresponding particular structured data request format including associated ancillary data and
a plurality of different data sources, to provide first configuration information;
associating said particular structured data request format with a plurality of different data sources, to provide second configuration information;
using said first and second configuration information for translating said received query for information in said first data format to a plurality of queries in different data formats for communication to said plurality of different data sources; and
receiving query reply messages in response to said plurality of queries communicated to said plurality of different data sources and for collating data in said query reply messages in a desired format in response to said ancillary data.

36. A method according to claim 35, comprising
implementing said method in an executable application embodied in a tangible storage medium.

37. A method for acquiring and processing data from a plurality of different data sources, comprising the activities of:
associating a received query for information in a first data format with,
a corresponding particular structured data request format and
a plurality of different data sources, to provide first predetermined configuration information;
associating said particular structured data request format with a plurality of different data sources, to provide second predetermined configuration information; and
using said first and second predetermined configuration information for translating said received query for information in said first data format to a plurality of queries in different data formats for communication to said plurality of different data sources.

38. A method according to claim 37, comprising
implementing said method in an executable application embodied in a tangible storage medium
